(19) United States
(12) Patent Application Publication
(10) Pub. No.: US 2023/0107727 A1
(43) Pub. Date: Apr. 6, 2023

(54) Pouch Type Rechargeable-Battery

(71) Applicant: SK On Co., Ltd., Seoul (KR)

(72) Inventors: Ho Jin Hwang, Daejeon (KR); Ji Hyung Kim, Daejeon (KR); Young Ha Kim, Daejeon (KR); Sang Bin Lee, Daejeon (KR)

(21) Appl. No.: 17/844,243

(22) Filed: Jun. 20, 2022

(30) Foreign Application Priority Data
Sep. 29, 2021 (KR) 10-2021-0128769

(51) Int. Cl. H01M 50/105; H01M 10/056

(52) U.S. Cl. CPC H01M 50/105; H01M 10/056

(57) ABSTRACT

A pouch type rechargeable-battery includes an electrode assembly including a first electrode plate, a separator, and a second electrode plate, and a pouch film in which the electrode assembly is accommodated. The pouch film includes an accommodation portion in which the electrode assembly is accommodated, and a terrace portion extending from the accommodation portion to an external side of the accommodation portion. The terrace portion includes a plurality of auxiliary accommodation portions in which an auxiliary electrolyte is accommodated.

### CROSS-REFERENCE TO RELATED APPLICATION

This application claims priority to Korean Patent Application No. 10-2021-0128769 filed Sep. 29, 2021, the disclosure of which is hereby incorporated by reference in its entirety.

### BACKGROUND OF THE INVENTION

### 1. Field of the Invention

The present disclosure relates to a pouch type rechargeable-battery.

### 2. Description of Related Art

Generally, in a secondary battery, as an electrochemical reaction occurs continuously, electrolyte depletion occurs due to decomposition of electrolyte solvent and sodium chloride (NaCl), and gas may be generated in the secondary battery such that internal pressure of the secondary battery may increase.

As such, when electrolyte is depleted, resistance in a secondary battery rapidly increases, and as an area of electrochemical reaction may be rapidly reduced, capacity may be reduced.

Also, lifespan of the secondary battery may be rapidly reduced.

### SUMMARY OF THE INVENTION

An aspect of the present disclosure is to provide a pouch type rechargeable-battery which may, by reducing depletion of electrolyte, increase lifespan.

According to an aspect of the present disclosure, a pouch type rechargeable-battery includes an electrode assembly including a first electrode plate, a separator, and a second electrode plate, and a pouch film in which the electrode assembly is accommodated, wherein the pouch film includes an accommodation portion in which the electrode assembly is accommodated, and a terrace portion extending from the accommodation portion to an external side of the accommodation portion, and wherein the terrace portion includes a plurality of auxiliary accommodation portions in which an auxiliary electrolyte is accommodated.

Lithium (Li) may be included in the auxiliary electrolyte accommodated in at least one auxiliary accommodation portion among the plurality of auxiliary accommodation portions.

Auxiliary electrolyte including lithium (Li) may include sodium chloride (NaCl).

The auxiliary electrolyte accommodated in at least one auxiliary accommodation portion of the plurality of auxiliary accommodation portions may be the same as electrolyte filled in the accommodation portion.

The plurality of auxiliary accommodation portions may include a first auxiliary accommodation portion filled with electrolyte the same as electrolyte filled in the accommodation portion, a second auxiliary accommodation portion disposed on an external side of the first auxiliary accommodation portion and filled with electrolyte including lithium (Li) and sodium chloride (NaCl), and a third auxiliary accommodation portion disposed on an external side of the second auxiliary accommodation portion and filled with electrolyte the same as electrolyte filled in the accommodation portion.

The terrace portion may include a sealing portion disposed on an external side of the auxiliary accommodation portion.

The sealing portion may include an adhesive or an auxiliary sealing member for bonding the sealing portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a pouch type rechargeable-battery according to an example embodiment of the present disclosure;

FIG. 2 is an exploded perspective diagram illustrating a pouch type rechargeable-battery according to an example embodiment of the present disclosure;

FIG. 3 is a diagram illustrating an auxiliary accommodation portion of a pouch type rechargeable-battery according to an example embodiment of the present disclosure; and

FIGS. 4 to 7 are diagrams illustrating operation of a pouch type rechargeable-battery according to an example embodiment of the present disclosure.

### DESCRIPTION OF THE INVENTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided such that this disclosure will be thorough and complete, and will fully convey the scope of the disclosure to those skilled in the art. Accordingly, shapes and sizes of the elements in the drawings may be exaggerated for clarity of description. Also, elements having the same function within the scope of the same concept represented in the drawing of each example embodiment will be described using the same reference numeral.

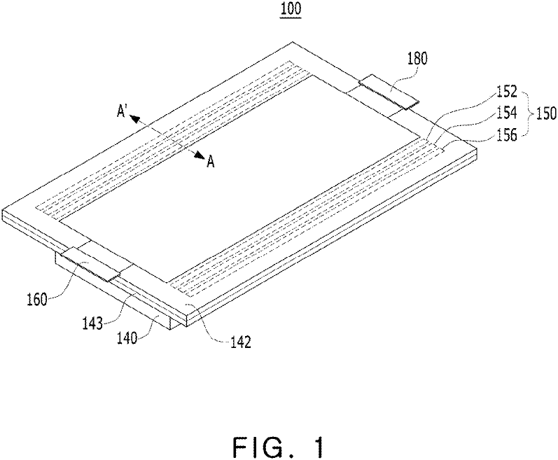

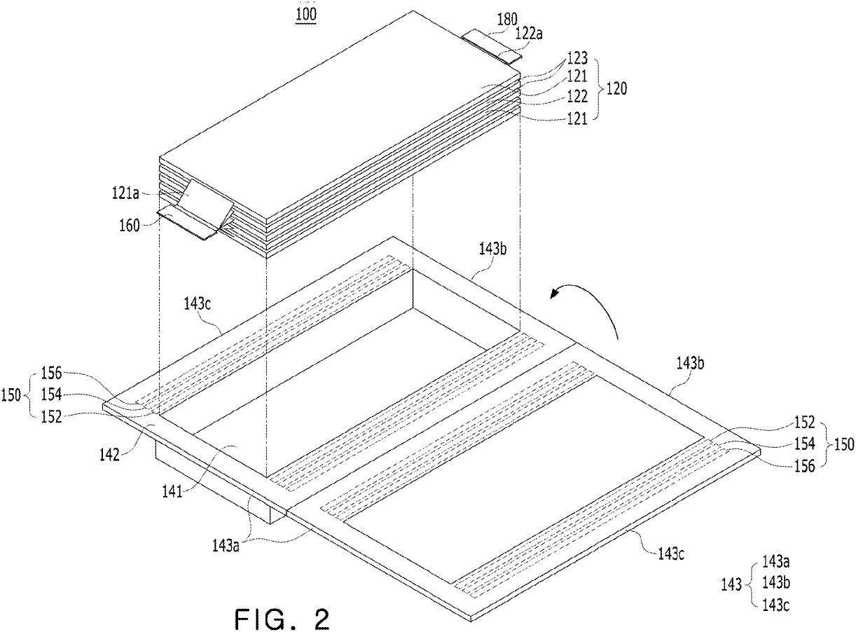

FIG. 1 is a perspective diagram illustrating a pouch type rechargeable-battery according to an example embodiment. FIG. 2 is an exploded perspective diagram illustrating a pouch type rechargeable-battery according to an example embodiment.

Referring to FIGS. 1 and 2, a pouch type rechargeable-battery 100 in an example embodiment may include an electrode assembly 120, a pouch film 140, a negative electrode lead 160, and a positive electrode lead 180.

The electrode assembly 120 may be accommodated in the internal space formed by the pouch film 130. As an example, the electrode assembly 120 may include a first electrode plate 121, a second electrode plate 122, and a separator 123, formed in a thin plate shape or a film shape, and may be formed in various forms if desired, such as a stacked type or a wound type. For example, the first electrode plate 121 may work as a cathode, and the second electrode plate 122 may work as an anode.

The first electrode plate 121 may be formed by coating a first electrode active material such as graphite or carbon on a first electrode current collector formed of, for example, a metal foil such as copper, a copper alloy, nickel, or a nickel alloy. Also, the first electrode plate 121 may include a first electrode uncoated portion 121a, not coated with the first electrode active material. The first electrode uncoated portion 121a may work as a path for a current flow between the first electrode plate 121 and an external region of the first electrode plate 121.

The second electrode plate 122 may be formed by, for example, coating a second electrode active material such as a transition metal oxide on a second electrode current collector formed of a metal foil such as aluminum or an aluminum alloy. Also, the second electrode plate 122 may include a second electrode uncoated portion 122a, not coated with the second electrode active material. The second electrode uncoated portion 122a may also work as a path for a current flow between the second electrode plate 122 and an external side of the second electrode plate 122.

The separator 123 may be disposed between the first electrode plate 121 and the second electrode plate 122, may prevent a short circuit and may allow movement of lithium ions. For example, the separator 123 may be formed of polyethylene, polypropylene, or a composite film of polyethylene and polypropylene.

As an example, the first electrode plate 121, the second electrode plate 122, and the separator 123 may be arranged in a height direction of the lower case 130. In other words, the first electrode plate 121, the separator 123, and the second electrode plate 122 may be alternately stacked in order from a bottom to the upper side of the pouch film 140.

The negative electrode lead 160 is connected to the uncoated portion 121a of the first electrode plate 121, and the positive electrode lead 180 is connected to the uncoated portion 122a of the second electrode plate 122.

The electrode assembly 120 may be accommodated in the pouch film 140, and the negative electrode lead 160 and the positive electrode lead 180 may protrude from both sides of the pouch film 140.

An accommodation portion 141 may be formed in the pouch film 140. Also, the bottom surface of the accommodation portion 141 may be formed to be flat. Also, the electrode assembly 120 may be inserted into the accommodation portion 141, and the pouch film 140 may be folded around one surface of the electrode assembly 120.

Also, the pouch film 140 may include a terrace portion 142 extending to an external side of the accommodation portion 141. The terrace portion 142 may be formed to extend from four sides of the accommodation portion 141, for example.

A portion of an edge of the terrace portion 142 may include a sealing portion 143. As an example, the sealing portion 143 may include a first side sealing portion 143a, a second side sealing portion 143b, and an upper sealing portion 143c. In this case, the pouch type rechargeable-battery 100 may accommodate the electrode assembly 120 by overlapping the accommodation portion 141, and the entire first and second side sealing portions 143a and 143b other than the upper sealing portion 143c may be bonded to each other, electrolyte E may be injected through the region in which the upper sealing portion 143c is disposed, and sealing may be performed. As such, in the pouch type rechargeable-battery 100, three edges of the four edges may be sealed. In other words, the sealing portion 143 including the first side sealing portion 143a, the second side sealing portion 143b, and the upper sealing portion 143c may be formed on the edge of the terrace portion 142.

Also, the terrace portion 142 may have a width greater than a width of the sealing portion 143. The sealing portion 143 may refer to a region bonded by, for example, thermal fusion in the terrace portion 142, and the terrace portion 142 other than the sealing portion 143 may maintain an unbonded state.

As an example, the sealing portion 143 may further include an adhesive (not illustrated) or an auxiliary sealing member (not illustrated) for bonding. That is, an adhesive or an auxiliary sealing member for bonding the terrace portion 142 may be provided in the sealing portion 143.

The electrolyte E may be formed by an organic solvent such as ethylene carbonate (EC), propylene carbonate (PC), diethyl carbonate (DEC), ethylmethyl carbonate (EMC), dimethyl carbonate (DMC) mixed with lithium salt such as LiPF₆ and LiBF₄. Also, the electrolyte E may be in the form of a liquid or a gel.

Also, the pouch film 140 may be formed of a laminate sheet including a metal layer and a resin layer. In particular, the laminate sheet may be an aluminum laminate sheet. As an example, the pouch film 140 may include a core formed of a metal layer, a heat sealing layer formed on an upper surface of the core, and an insulating film formed on a lower surface of the core.

The heat sealing layer may act as an adhesive layer using modified polypropylene, a polymer resin, such as casted polypropylene (CPP), and the insulating film may be formed of a resin material such as nylon or polyethylene terephthalate (PET). The structure and material of a pouch film are not limited to the above examples.

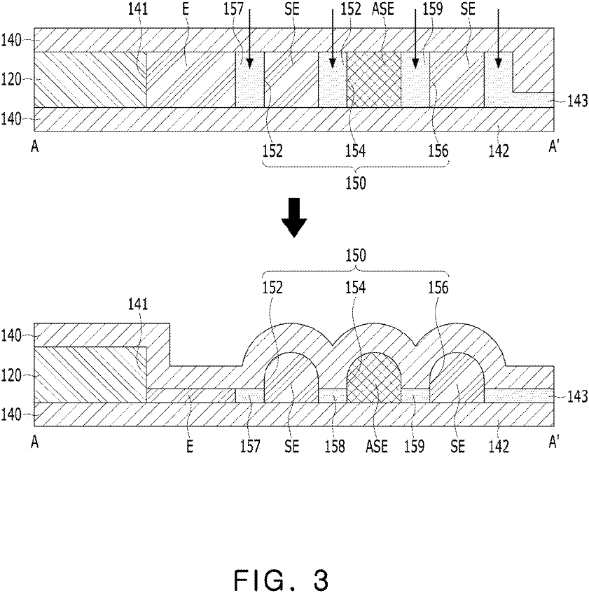

The terrace portion 142 may include a plurality of auxiliary accommodation portion 150 in which auxiliary electrolyte SE is accommodated. As an example, the plurality of auxiliary accommodation units 150 may be disposed on the two terrace portions 142 disposed on a long side of the pouch film 140. The plurality of auxiliary accommodation portion 150 may include a first auxiliary accommodation portion 152 filled with electrolyte SE the same as electrolyte E accommodated in the accommodation portion 141, a second auxiliary accommodation portion 154 disposed on an external side of the first auxiliary accommodation portion 152 and accommodating electrolyte ASE including lithium (Li) and sodium chloride (NaCl), and a third auxiliary accommodation portion 156 disposed on an external side of the second auxiliary accommodation portion 154 and filled with electrolyte SE the same as the electrolyte E filled in the accommodation portion 141. As illustrated in FIG. 3, first, second, and third auxiliary sealing units 157, 158, and 159 may be formed between the accommodation portion 141 and the first auxiliary accommodation portion 152, between the first auxiliary accommodation portion 152 and the second auxiliary accommodation portion 154, and between the second auxiliary accommodation portion 154 and the third auxiliary accommodation portion 156.

Accordingly, as the first, second, and third auxiliary accommodation portions 152, 154, and 156 may be opened in sequence by gas generated while the pouch type rechargeable-battery 100 is used, and the electrolyte may be supplemented in the accommodation portion 141.

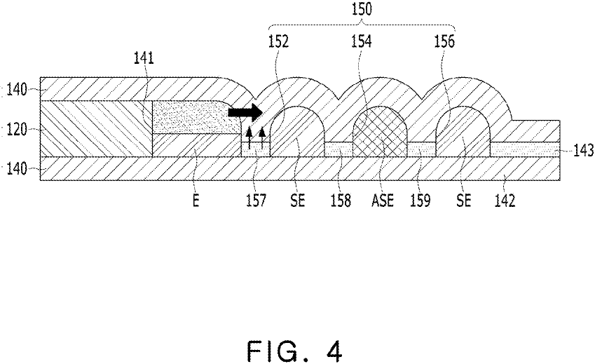

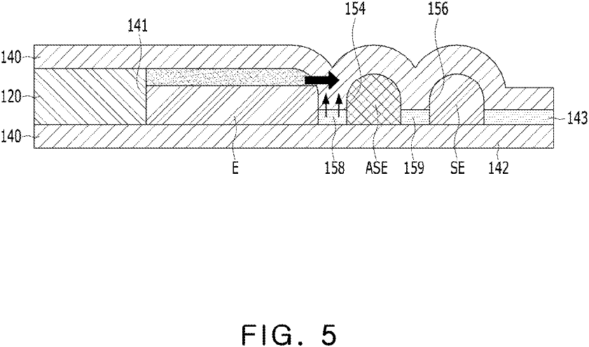

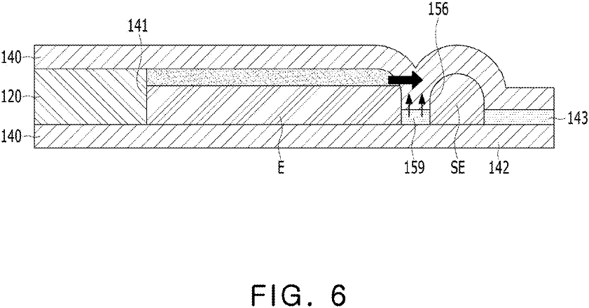

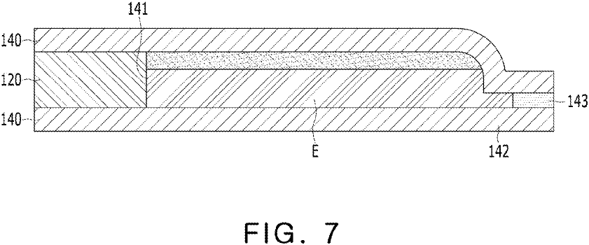

Specifically, as illustrated in FIG. 4, gas generated as the pouch type rechargeable-battery 100 is used may be filled in the accommodation portion 141, and accordingly, internal pressure of the pouch film 140 may increase. Thereafter, when the internal pressure of the pouch film 140 is equal to or greater than a predetermined pressure, as illustrated in FIG. 5, the first auxiliary sealing unit 157 may be opened and the electrolyte SE accommodated in the first auxiliary accommodation portion 152 may be supplemented in the accommodation portion 141. Thereafter, the internal pressure of the pouch film 140 may increase by gas generated by continuous use of the pouch type rechargeable-battery 100. Thereafter, when the internal pressure of the pouch film 140 is equal to or greater than a predetermined pressure, as illustrated in FIG. 6, the second auxiliary sealing unit 158 may be opened and the electrolyte solution ASE accommodated in the second auxiliary accommodation portion 154 may be supplemented in the accommodation portion 141. Since lithium (Li) and sodium chloride (NaCl) are included in the electrolyte accommodated in the second auxiliary accommodation portion 154, a decrease in viscosity of the electrolyte E may be prevented, and ionic conductivity may improve. Thereafter, the internal pressure of the pouch film 140 may increase by gas generated by continuous use of the pouch type rechargeable-battery 100. When the internal pressure of the pouch film 140 is equal to or greater than a predetermined pressure, as illustrated in FIG. 7, the third auxiliary sealing unit 159 may be opened and the electrolyte SE accommodated in the third auxiliary accommodation portion 156 may be supplemented in the accommodation portion 141.

As described above, by supplementing the electrolyte SE and ASE accommodated in the auxiliary accommodation portion 150 according to the period of use of the pouch type rechargeable-battery 100, lifespan of the pouch type rechargeable-battery 100 may increase.

The negative electrode lead 160 may be electrically connected to the uncoated portion 121a of the first electrode plate 121, and one end may be disposed to protrude from the pouch film 140. As an example, the negative electrode lead 160 may be formed of copper, a copper alloy, nickel, or a nickel alloy material, which may be the same material as that of the first electrode plate 121. The negative electrode lead 160 may be connected to the first electrode plate 121 through a current collector (not illustrated). Also, the negative electrode lead 160 and the current collector may be bonded by welding. As an example, a sealing film (not illustrated) may be installed on the negative electrode lead 160, and the sealing film may be disposed in the first side sealing portion 143a.

The positive electrode lead 180 may be electrically connected to the uncoated portion 122a of the second electrode plate 122, and one end may protrude from the pouch film 140. As an example, the positive electrode lead 180 may be formed of aluminum or an aluminum alloy material, the same material as that of the second electrode plate 122. Also, the positive electrode lead 180 may also be connected to the second electrode plate 122 through a current collector (not illustrated). The positive electrode lead 180 and the current collector may be bonded by welding. As an example, a sealing film (not illustrated) may be installed on the positive electrode lead 180, and the sealing film may be disposed in the second side sealing portion 143b.

As described above, since the electrolyte E may be supplemented in the accommodation portion 141 through the plurality of auxiliary accommodation portions 150, lifespan of the pouch type rechargeable-battery 100 may increase.

According to the aforementioned example embodiments, by reducing depletion of electrolyte, the lifespan of the battery may increase.

While the example embodiments have been illustrated and described above, it will be apparent to those skilled in the art that modifications and variations could be made without departing from the scope of the present disclosure as defined by the appended claims.

What is claimed is:

1. A pouch type rechargeable-battery, comprising:
an electrode assembly including a first electrode plate, a separator, and a second electrode plate; and
a pouch film in which the electrode assembly is accommodated,
wherein the pouch film includes an accommodation portion in which the electrode assembly is accommodated, and a terrace portion extending from the accommodation portion to an external side of the accommodation portion, and
wherein the terrace portion includes a plurality of auxiliary accommodation portions in which an auxiliary electrolyte is accommodated.

2. The pouch type rechargeable-battery of claim 1,
wherein lithium (Li) is included in the auxiliary electrolyte accommodated in at least one auxiliary accommodation portion among the plurality of auxiliary accommodation portions.

3. The pouch type rechargeable-battery of claim 2, wherein auxiliary electrolyte including lithium (Li) includes sodium chloride (NaCl).

4. The pouch type rechargeable-battery of claim 1, wherein the auxiliary electrolyte accommodated in at least one auxiliary accommodation portion of the plurality of auxiliary accommodation portions is the same as electrolyte filled in the accommodation portion.

5. The pouch type rechargeable-battery of claim 1, wherein the plurality of auxiliary accommodation portions include a first auxiliary accommodation portion filled with electrolyte the same as electrolyte filled in the accommodation portion, a second auxiliary accommodation portion disposed on an external side of the first auxiliary accommodation portion and filled with electrolyte including lithium (Li) and sodium chloride (NaCl), and a third auxiliary accommodation portion disposed on an external side of the second auxiliary accommodation portion and filled with electrolyte the same as electrolyte filled in the accommodation portion.

6. The pouch type rechargeable-battery of claim 1, wherein the terrace portion includes a sealing portion disposed on an external side of the auxiliary accommodation portion.

7. The pouch type rechargeable-battery of claim 6, wherein the sealing portion includes an adhesive or an auxiliary sealing member for bonding the sealing portion.
